(19) United States
(12) Patent Application Publication
(10) Pub. No.: US 2022/0177371 A1
(43) Pub. Date: Jun. 9, 2022

(54) DIELECTRIC CERAMICS, METHOD FOR PREPARING THE SAME, AND MULTILAYERED ELECTRIONIC COMPONENT COMPRISING THE SAME

(71) Applicant: KOREA ADVANCED INSTITUTE OF SCIENCE AND TECHNOLOGY, Daejeon (KR)

(72) Inventors: Sung-Yoon CHUNG, Daejeon (KR); Ji-Sang AN, Daejeon (KR); Hae Seung LEE, Daejeon (KR)

(21) Appl. No.: 17/531,923

(22) Filed: Nov. 22, 2021

(30) Foreign Application Priority Data
Dec. 7, 2020 (KR) 10-2020-0169771

(51) Int. Cl. C04B 35/468; H01G 4/12; H01G 4/248; C04B 35/64

(52) U.S. Cl. CPC C04B 35/4682; H01G 4/1227; H01G 4/30; C04B 35/64; H01G 4/248

(57) ABSTRACT

Disclosed are a dielectric ceramic includes a plurality of crystal grain bulks including a ceramic, and a grain boundary between the plurality of crystal grain bulks, wherein a dopant is segregated in the grain boundary.

### CROSS-REFERENCE TO RELATED APPLICATION

This application claims priority to and the benefit of Korean Patent Application No. 10-2020-0169771 filed in the Korean Intellectual Property Office on Dec. 7, 2020, the entire contents of which are incorporated herein by reference.

### BACKGROUND OF THE INVENTION

### (a) Field of the Invention

The present disclosure relates to a dielectric ceramic, a method for preparing the same, and a multi-layered electronic component including the same.

### (b) Description of the Related Art

In the era of the 4th industrial revolution, the development of electronic devices, autonomous vehicles, and wireless communication devices is rapidly progressing. Accordingly, there is a need for research and development to develop more high-performance equipment and technologies. Various characteristics are also required for the passive elements of the circuit used in these equipment and technologies. One of the demands is to gradually improve performance of a capacitor, which is one passive element storing electrical energy and thus stably supplying a current and acting as a filter between AC and DC.

Among various types of capacitors, a multi-layer ceramic capacitor (MLCC) is the most widely used. The multi-layer ceramic capacitor has a stacked structure of ceramic dielectric layers and metal electrode layers. The multi-layer ceramic capacitor enables the most efficient accumulation of electrical energy compared to the device volume due to the unique structure. As for the ceramic dielectric layers in the multi-layer ceramic capacitor, barium titanate (BaTiO₃) is used as a main material. The barium titanate is harmless to the environment and human body, and has a high relative permittivity, so it can store high-density energy.

However, when used as a single composition, the barium titanate has various problems such as a high dielectric loss, low temperature stability due to a low Curie temperature (T_{C}), and a low withstand voltage. Accordingly, various studies are being conducted to complement and develop the barium titanate. Most of studies on a barium titanate dielectric are focused on further increasing the relative permittivity through doping, and also increasing stability through formation of a core-shell structure. However, intensive and rational studies on the dielectric loss has rarely been conducted.

In order to secure the efficient energy storage, it is very essential to minimize an energy loss as well as store a large amount of the applied electric field energy. In other words, in order to accomplish efficient energy management and regulation as a dielectric, a low dielectric loss property is required.

In general, a dielectric has different dielectric properties depending on a frequency, and these dielectric properties are basically affected by intrinsic/extrinsic factors. First, as for the intrinsic factor, the dielectric loss is greatly increased in a section where a relative permittivity gradually decreases. As the frequency in the electric field is increased, the type and number of polarizations that may react in the dielectric are reduced, and then the relative permittivity decreases gradually. In addition, a ferroelectric may have a domain structure, and in a high frequency region of several tens of MHz or higher, domains and crystal grains physically react to absorb the electric field, resulting in decreasing the relative permittivity and increasing the dielectric loss at high frequencies. In order to reduce the high dielectric loss at high frequencies, it is necessary to reduce a size and the number of the domain structures by minimizing the crystal grains size of the ferroelectrics.

In addition, the extrinsic factor may have various and complex causes. However, an influence of grain boundaries is one of the most important factors. This can be inferred from radically different dielectric properties between single-crystalline and polycrystalline barium titanate in a low frequency region of several tens of MHz or less. The grain boundaries are structurally discontinuous regions within a polycrystal. In order to suppress an increase of the dielectric loss due to the grain boundaries, it is necessary to reduce the electrical instability by relaxing potential barriers of the grain boundaries.

### SUMMARY OF THE INVENTION

An embodiment provides a dielectric ceramic exhibiting a consistently low dielectric loss in a wide alternating frequency range, while exhibiting an effective dielectric loss reduction characteristic even in a high frequency region. To this end, a growth of crystal grains is suppressed in polycrystals, and a decrease in tetragonality and ferroelectricity is induced.

Another embodiment provides a method for preparing the dielectric ceramic.

Another embodiment provides a multi-layered electronic component including the dielectric ceramic.

According to an embodiment, a dielectric ceramic includes a plurality of crystal grain bulks including a ceramic represented by Chemical Formula 1, and a grain boundary between the plurality of crystal grain bulks, wherein a dopant is segregated at the grain boundary.

ABO₃ [Chemical Formula 1]

In Chemical Formula 1, A necessarily includes Ba and may further include Ca, Sr, or a combination thereof, and B necessarily includes Ti and may further include Zr, Hf, Sn, or a combination thereof.

The dopant may include Mn, Fe, Ni, Co, Al, Ga, or a combination thereof.

The dopant may further include Nb, Ta, La, Sm, Dy, or a combination thereof.

The dopant may be present in an amount of greater than or equal to about 90 mol % based on the total moles of the dopant within about 5 nm from the center of the grain boundary.

The dopant may be present in an amount of about 85 mol % to about 95 mol % based on the total moles of the dopant within 2 nm from the center of the grain boundary.

The crystal grain bulk may have an average grain diameter of less than or equal to about 150 nm.

The dopant may be included in an amount of about 0.01 parts by mole to about 0.20 parts by mole based on 1 part by mole of the ceramic.

A tetragonality of the plurality of crystal grain bulks may range about 1 to about 1.005.

The dielectric ceramic may have a dielectric loss of less than or equal to about 1% in a frequency region of less than or equal to about 100 MHz.

According to another embodiment, a method of preparing a dielectric ceramic includes: preparing a crystallized ceramic powder; mixing a dopant precursor with the crystallized ceramic powder to prepare a mixture; and sintering the mixture at a temperature of less than or equal to about 1300° C.

The crystallized ceramic powder may have an average particle diameter of less than or equal to about 50 nm.

The dopant precursor may include MnO, Fe₂O₃, NiO, CoO, Al₂O₃, Ga₂O₃, or a combination thereof.

The dopant precursor may further include Nb₂O₅, Ta₂O₅, La₂O₃, Sm₂O₃, Dy₂O₃, or combination thereof.

The dopant precursor may be included in an amount of about 0.01 parts by mole to about 0.20 parts by mole based on 1 part by mole of the ceramic powder.

The dopant precursor may have an average particle diameter of less than or equal to about 200 nm.

The mixture may include SiO₂ in an amount of about 0.1 parts by mole to about 10 parts by mole based on 100 parts by mole of the ceramic powder.

The sintering of the mixture may be performed at a temperature of about 1000° C. to about 1300° C. for a time of less than or equal to about 5 hours.

According to another embodiment, a multi-layered electronic component includes: a body including a dielectric layer and an internal electrode; and an external electrode disposed on the body and connected to the internal electrode, wherein the dielectric layer includes the dielectric ceramic according to an embodiment.

The dielectric ceramic suppresses the growth of crystal grains in polycrystals and induces reduction of tetragonality and ferroelectricity, thereby exhibiting a consistently low dielectric loss in a wide alternating frequency range, and effectively reducing dielectric loss even in a high frequency region.

### BRIEF DESCRIPTION OF THE DRAWINGS

FIG. 1 is a schematic view illustrating a ceramic dielectric according to an embodiment.

FIG. 2 is a cross-sectional view schematically illustrating a multi-layered electronic component according to another embodiment.

FIG. 3 is an image obtained by measuring distribution positions of dopants and elements for each dielectric by energy dispersive spectroscopy. Each dielectric is a variety of dopant grain boundary segregated dielectrics subjected to heat treatment in a 0.5% H₂/N₂ sintering atmosphere.

FIG. 4 is a view illustrating quantitative comparison of the relative dopant concentrations within grains and between grain boundaries by energy dispersive spectroscopy for a representative dielectric. Each dielectric is a variety of dopant grain boundary segregated dielectrics subjected to heat treatment in a 0.5% H₂/N₂ sintering atmosphere.

FIG. 5 is an image showing grain boundary regions at an atomic level using a scanning transmission electron microscope for a representative dielectric. Each dielectric is a variety of dopant grain boundary segregated dielectrics subjected to heat treatment in a 0.5% H₂/N₂ sintering atmosphere.

FIG. 6 is an image obtained by measuring the distribution trend of dopant elements with respect to the grain boundary center for a representative dielectric using electron energy loss spectroscopy. Each dielectric is a variety of dopant grain boundary segregated dielectrics subjected to heat treatment in a 0.5% H₂/N₂ sintering atmosphere.

FIG. 7 is a view showing the microstructure and average particle size using scanning electron microscopy for a barium titanate dielectric having a single composition and various dopant grain boundary segregated dielectrics.

FIG. 8 is a view illustrating a comparison of dielectric properties according to frequency of single-crystalline and polycrystalline barium titanate dielectrics having a single composition and various dopant grain boundary segregated dielectrics subjected to heat treatment in a 0.5% H₂/N₂ sintering atmosphere.

FIG. 9 is a view illustrating a comparison of dielectric properties according to frequency of various dopant grain boundary segregated dielectrics subjected to heat treatment for sintering in the atmosphere.

FIG. 10 is a view illustrating a comparison of dielectric properties according to frequency of various dopant grain boundary segregated dielectrics subjected to heat treatment in a 1% H₂/N₂ sintering atmosphere.

FIG. 11 is a comparative view of dielectric properties according to frequency between a dopant solid solution structure and a dopant grain boundary segregation structure, and a view showing an image measured by energy dispersive spectroscopy of each element. In the dopant solid solution structure, a dopant is uniformly distributed at grain boundaries and inside grain boundaries. In the dopant grain boundary segregation structure, a dopant is selectively distributed at grain boundaries.

FIG. 12 is a view illustrating polarization hysteresis curves measured according to an electric field for a barium titanate dielectric having a single composition and various dopant grain boundary segregated dielectrics.

### DETAILED DESCRIPTION OF THE EMBODIMENTS

The advantages and features of the present disclosure and the methods for accomplishing the same will be apparent from the embodiments described hereinafter with reference to the accompanying drawings. However, the embodiments should not be construed as being limited to the embodiments set forth herein. Unless otherwise defined, all terms (including technical and scientific terms) used herein have the same meaning as commonly understood by one of ordinary skill in the art. In addition, terms defined in a commonly used dictionary are not to be ideally or excessively interpreted unless explicitly defined.

In addition, unless explicitly described to the contrary, the word “comprise,” and variations such as “comprises” or “comprising,” will be understood to imply the inclusion of stated elements but not the exclusion of any other elements.

A ceramic polycrystal having a single composition exhibits a relatively high dielectric loss in a low frequency region, whereas a ceramic single-crystal exhibits an extremely low dielectric loss at the low frequencies. A significant difference in dielectric properties between single-crystals and polycrystals may come from the extrinsic factor, whether or not they have a grain boundary structure. Accordingly, even as for the polycrystals, if an influence of electrical instability due to the grain boundary structure is minimized, a low dielectric loss may be obtained.

The grain boundary region due to the discontinuous structure has electrically unstable potential barriers. Such an electrically unstable state delays a response to polarizations according to an AC electric field, resultantly increasing the dielectric loss.

Accordingly, a ceramic dielectric according to an embodiment has a structure of selectively dopant-segregating only a grain boundary region of a polycrystalline dielectric in order to alleviate the influence of the electrically unstable grain boundary region.

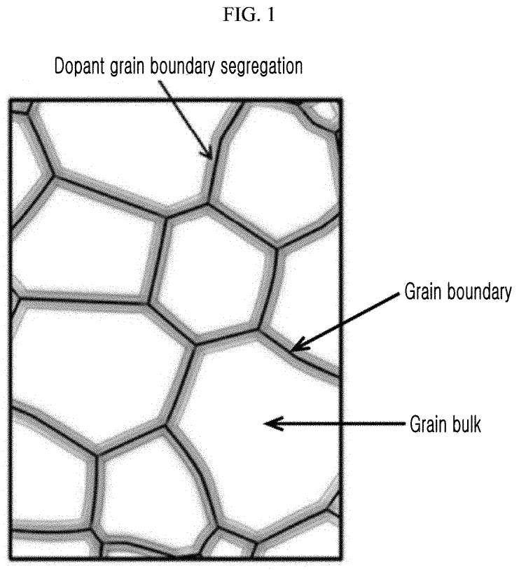

FIG. 1 is a schematic view illustrating the ceramic dielectric according to an embodiment.

Referring to FIG. 1, the ceramic dielectric includes a plurality of crystal grain bulks, and a grain boundary between the plurality of crystal grain bulks. The grain boundary may be a boundary between crystal grains in a polycrystalline ceramic.

The crystal grain bulk may include a ceramic represented by Chemical Formula 1.

ABO₃ [Chemical Formula 1]

In Chemical Formula 1, A necessarily includes Ba and may further include Ca, Sr, or a combination thereof, and B necessarily includes Ti and may further include Zr, Hf, Sn, or a combination thereof.

For example, the ceramic may include BaTiO₃, (Ba, Ca)(Ti, Ca)O₃, (Ba, Ca)(Ti, Zr)O₃, Ba(Ti, Zr)O₃, (Ba, Ca)(Ti, Sn)O₃, or a combination thereof.

The ceramic may include a dopant that acts as an acceptor to the ceramic so as to maintain insulation even under reduction sintering conditions. These acceptor dopants are Mn, Fe, Ni, Co, Al, Ga, or a combination thereof.

In addition, the ceramic may additionally include a donor dopant along with an acceptor dopant. The donor dopant may be Nb, Ta, La, Sm, Dy, or a combination thereof. However, the content of the acceptor dopant may be greater than the content of the donor dopant in order to maintain insulation under the reduction sintering condition.

Meanwhile, the dopant has a segregated structure at the grain boundary. That is, most of the dopant is disposed near the grain boundary rather than in the crystal grain bulk.

As described later, the grain boundary segregation structure of the dopant may be obtained by using a ceramic powder with an average particle diameter of about 50 nm and simultaneously mixing it with an excess of the dopant. In the grain boundary segregation structure of the dopant, the dopant is locally distributed in the grain boundary region of a polycrystalline dielectric.

Through this selective grain boundary segregation of the excess dopant, the dielectric loss increase effect due to the grain boundaries in the polycrystals may be greatly reduced. In addition, even the dielectric loss reduction effect may be promoted at a high frequency of tens of MHz or higher by using the nano-size ceramic powder.

In the structure in which the dopant is segregated at the grain boundaries, about 90 mol % or more of the dopant based on the total moles of the dopant may be present within about 5 nm from a center of a grain boundary, and about 85 mol % or more of the dopant, for example, about 85 mol % to about 95 mol % of the dopant based on the total moles of the dopant may be present within about 2 nm from the center of the grain boundary. When the dopant is present at less than about 90 mol % within about 5 nm from the center of the grain boundary, the grain boundary segregation structure of the dopant may not be obtained, and thereby, an effective dielectric loss reduction effect at a low frequency of about 10 MHz or less may not be obtained, resulting in more than necessary growth of crystal grains.

As the grain boundary segregation structure of the dopant is prepared by using a ceramic powder with an average particle diameter of about 50 nm or less, a crystal grain bulk may have an average grain diameter of about 150 nm or less, for example, about 100 nm to about 150 nm. When the crystal grain bulk has an average grain diameter of greater than about 150 nm, the dielectric loss may increase at a frequency of about 100 MHz or higher due to an increase in tetragonality and ferroelectricity.

In addition, as the grain boundary segregation structure of the dopant is prepared by using an excessive amount of the dopant, the dopant may be included in an amount of about 0.01 parts by mole to about 0.20 parts by mole, for example, about 0.02 parts by mole to about 0.05 parts by mole, based on 1 part by mole of the ceramic. When the dopant is included in an amount of less than about 0.01 parts by mole, the grain boundary segregation structure of the dopant may not be formed due to a relatively small concentration of the dopant, thereby having no dielectric loss reduction effect. In addition, there may be an insignificant effect of inhibiting the crystal grain growth due to the low dopant concentration. When the dopant is used in an amount of greater than about 0.20 parts by mole, the dopant may be left even after being sufficiently used for forming the dopant grain boundary segregation structure and flow into the crystal grains or produce a large amount of secondary phases, increasing the dielectric loss.

The plurality of crystal grain bulks may have may have tetragonality of about 1 to about 1.005, for example about 1 to about 1.003. When the tetragonality of the crystal grain bulks exceeds about 1.005, the ferroelectricity increases, and accordingly, the dielectric loss may rapidly increase at a high frequency of 100 MHz or more.

Since the dielectric ceramic has a grain boundary segregation structure of excess dopant, it may have a dielectric loss of less than or equal to about 1% in a frequency region of less than or equal to about 100 MHz, or for example less than or equal to about 2.5% in a frequency region of less than or equal to about 1 GHz.

A method of preparing a dielectric ceramic according to another embodiment includes preparing a crystallized ceramic powder, mixing a dopant precursor with the crystallized ceramic powder to prepare a mixture, and sintering the mixture.

In general, when a dopant is doped, or a solid solution is prepared, a ceramic is mixed with dopant elements and then heat-treated for the crystallization. However, a method of preparing the dielectric ceramic according to an embodiment is performed by first mixing crystallized ceramic powder with an excessive amount of dopant precursor powder in order to form the grain boundary segregation structure of dopant elements after the sintering.

In addition, in order to more effectively reduce the crystal grain size, the average particle diameter of the crystallized ceramic powder may be less than or equal to about 50 nm, for example, about 10 nm to about 50 nm. When the crystallized ceramic powder has an average particle diameter of about 50 nm or less, the crystal grain size of a grain boundary-segregated polycrystalline dielectric may be reduced, through which tetragonality and ferroelectricity are effectively lowered, thereby showing the more effective dielectric loss reduction at a high frequency of about 100 MHz or higher. In other words, a single-phased ceramic, when nano-sized powder is used, exhibits active growth of crystal grains, but in the method of preparing a dielectric ceramic according to another embodiment, the grain boundary segregation structure of the excess dopant is maintained and thus may effectively suppress crystal grain growth of the nano-sized ceramic.

Next, the crystallized ceramic powder and the dopant precursor powder are mixed.

The dopant precursor may be a precursor of a dopant that acts as an acceptor, and may be MnO, Fe₂O₃, NiO, CoO, Al₂O₃, Ga₂O₃, or a combination thereof. In addition, it may further include a donor dopant in addition to the acceptor dopant. In this case, the donor dopant precursor may be Nb₂O₅, Ta₂O₅, La₂O₃, Sm₂O₃, Dy₂O₃, or a combination thereof.

In order to form a grain boundary segregation structure of the dopant, the dopant precursor may be included in an amount of about 0.01 parts by mole to about 0.20 parts by mole, or for example 0.02 parts by mole to 0.05 parts by mole, based on 1 part by mole of the ceramic powder. When the content of the dopant precursor is less than about 0.01 parts by mole, the grain boundary segregation structure of the dopant may not be formed due to a relatively small dopant concentration, failing in obtaining the dielectric loss reduction effect. In addition, the crystal grain growth may not be sufficiently suppressed due to the low dopant concentration. When the content of the dopant precursor is greater than about 0.20 parts by mole, the dopant may still be left after being sufficiently used for forming the grain boundary segregation structure of the dopant and flow into the crystal grains or generates a large amount of secondary phases, increasing the dielectric loss.

On the other hand, when the dopant precursor is also nano-sized, the segregation of the dopant at the grain boundaries may be more easily induced. The dopant precursor may have an average particle diameter of about 200 nm or less, for example, about 30 nm to about 100 nm. When the dopant precursor has an average particle diameter of greater than about 200 nm, the dopant may be ununiformly distributed and thus not effectively flow into the dielectric grain boundary region, which may not effectively accomplish the dielectric loss reduction at a low frequency of about 10 MHz or less and may hinder the suppression of the crystal grain growth.

In addition, the mixture may further include SiO₂ for easy densification during the sintering process. The mixture may include SiO₂ in an amount of about 0.1 parts by mole to about 10 parts by mole based on about 100 parts by mole of the ceramic powder, for example, about 1 part by mole to about 2 parts by mole. When SiO₂ is included in an amount of less than about 0.1 parts by mole, densification of a dielectric may be insufficient, insulation resistance may be reduced, and the like, which result in deteriorating stability, but when SiO₂ is included in an amount of greater than about 10 parts by mole, the secondary phases may be generated due to an excess of SiO₂, which may also reduce insulation resistance and decrease the relative permittivity.

Subsequently, a sintering heat treatment for a relatively short time may be performed to induce non-equilibrium segregation of the dopant and effectively form the grain boundary segregation structure of the dopant.

In order to prevent the dopant elements mixed in the ceramic powder from flowing into the ceramic bulk during the sintering and maintain the non-equilibrium state that the dopant is segregated only at the grain boundaries, the sintering heat treatment is performed at a relatively low temperature of about 1300° C. or less, preparing a polycrystalline dielectric having the grain boundary segregation of the dopant.

Accordingly, the sintering temperature may be about 1300° C. or less, for example, about 1000° C. to about 1300° C., and sintering time may be about 5 hours or less, for example, about 0.5 hours to about 2 hours. When the sintering temperature is greater than about 1300° C., or the sintering time is greater than about 5 hours, the dopant elements are diffused to an equilibrium state and thus may not form a grain boundary segregation structure of the dopant but change it into a solid solution structure of the dopant, in which the dopant is diffused to the crystal grain bulk, thereby increasing the dielectric loss. On the other hand, when the sintering temperature is less than about 1000° C., or the sintering time is less than about 0.5 hours, the dielectric is not sufficiently densified, lowering the insulation resistance or increasing the dielectric loss. In other words, through a heat treatment at a relatively low temperature for a short time, the structure in which dopant elements are segregated at polycrystalline dielectric grain boundaries in a non-equilibrium state may be formed.

The method of preparing a dielectric ceramic according to an embodiment may maintain a low dielectric loss within a wide alternating frequency by selectively segregating the excess dopant at the ceramic polycrystalline grain boundaries. In other words, the excess dopant is mixed with crystallized ceramic powder and then heat-treated through sintering to form a dopant non-equilibrium segregation structure in a grain boundary region, manufacturing a polycrystalline dielectric having a grain boundary segregation structure of the dopant.

In this way, the dopant segregated at the grain boundaries may lower potential barriers, and as a result, the dielectric loss reduction effect at a low frequency may be effectively obtained. In addition, the crystal grain growth may be suppressed by forming the grain boundary segregation structure of the excess dopant and using the nano-sized ceramic powder to induce a decrease in tetragonality and ferroelectricity, and resultantly, effectively obtaining the dielectric loss reduction effect even at a high frequency.

A multi-layered electronic component according to another embodiment includes a body including a dielectric layer and an internal electrode and an external electrode disposed on the body and connected to the internal electrode.

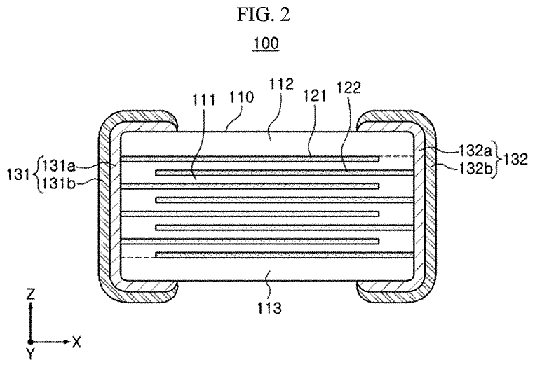

FIG. 2 is a cross-sectional view schematically illustrating a multi-layered electronic component according to an embodiment.

Referring to FIG. 2, a multi-layered electronic component 100 includes: a body 110 including a dielectric layer 111 and internal electrodes 121 and 122; and external electrodes 131 and 132 disposed on the body 110 and connected to the internal electrodes 121 and 122.

Herein, the dielectric layer 111 includes a dielectric ceramic according to an embodiment. Since the contents of the dielectric ceramic are the same as those described above, a repeated description will be omitted.

In the body 110, the dielectric layer 111 and the internal electrodes 121 and 122 are alternately stacked.

The body 110 has no particular limit with respect to its specific shape but as shown above, may have a hexahedral shape or a similar shape thereto. During the sintering, due to shrinkage of ceramic powder in the body 110, the body 110 may have a substantially hexahedral shape, such that it is not formed of a perfectly straight line.

The body 110 may have first and second surfaces facing each other in a first direction (Z direction), third and fourth surfaces connected to the first and second surfaces and facing each other in a second direction (X direction), and fifth and sixth surfaces connected to the first and second surfaces and also to the third and fourth surfaces and facing each other in a third direction (Y direction).

A plurality of the dielectric layers 111 form the body 110, and when in a sintered state, the boundaries of the neighboring dielectric layers 111 are integrated to the extent that may not be confirmed without a scanning electron microscope (SEM).

On the other hand, the body 110 may include a capacitance forming portion including a first internal electrode 121 and a second internal electrode 122 disposed to face each other with the dielectric layer 111 therebetween and thus forming capacitance and cover portions 112 and 113 above and below the capacitance forming portion.

In addition, the capacitance forming portion contributes to forming capacitance of a capacitor and may be formed by repeatedly stacking the plurality of first and second internal electrodes 121 and 122 with the dielectric layer 111 therebetween.

The upper cover portion 112 and the lower cover portion 113 may be formed by stacking a single dielectric layer or two or more dielectric layers on the upper and lower surfaces of the capacitance forming portion respectively in a thickness direction and basically play a role of preventing damage to the internal electrodes due to physical or chemical stress.

The upper cover portion 112 and the lower cover portion 113 include no internal electrodes but may include the same material as the dielectric layer 111.

In other words, the upper cover portion 112 and the lower cover portion 113 may include a ceramic material, for example, a barium titanate (BaTiO₃)-based ceramic material.

The internal electrodes 121 and 122 are alternately stacked with the dielectric layer 111.

The internal electrodes 121 and 122 may include the first and second internal electrodes 121 and 122. The first and second internal electrodes 121 and 122 are alternately arranged to face each other with the dielectric layer 111 constituting the body 110 therebetween and may be exposed to the third and fourth surfaces of the body 110.

The first internal electrode 121 is spaced apart from the fourth surface and exposed through the third surface, and the second internal electrode 122 is spaced apart from the third surface and exposed through the fourth surface.

Herein, the first and second internal electrodes 121 and 122 may be electrically isolated from each other by the dielectric layer 111 disposed therebetween.

The body 110 may be formed by alternately stacking a ceramic green sheet on which the first internal electrode 121 is printed and another ceramic green sheet on which the second internal electrode 122 is printed, and then sintering. The internal electrodes 121 and 122 have no particular limit but may be formed of a material with excellent electrical conductivity.

For example, the internal electrodes 121 and 122 may be formed by printing a conductive paste for internal electrodes including at least one of palladium (Pd), nickel (Ni), copper (Cu), and an alloy thereof on the ceramic green sheet.

A method of printing the conductive paste for internal electrodes may include screen printing, gravure printing, or the like, but the present invention is not limited thereto.

In addition, the first and second external electrodes 131 and 132 respectively disposed on the third and fourth surfaces of the body 110 and respectively connected to the first and second internal electrodes 121 and 122 may be included.

The present embodiment illustrates that the multi-layered electronic component 100 has the two external electrodes 131 and 132, but the number and shape of the external electrodes 131 and 132 may be changed depending on a shape of the internal electrodes 121 and 122 or other purposes.

On the other hand, the external electrodes 131 and 132 may be formed of any material having electrical conductivity such as a metal and the like, and specific materials thereof may be determined in consideration of electrical characteristics, structural stability, and the like, and furthermore, a multi-layer structure may be adopted.

For example, the external electrodes 131 and 132 may include the electrode layers 131a and 132a disposed on the body 110 and plating layers 131b and 132b formed on the electrode layers 131a and 132a.

Specific examples of the electrode layers 131a and 132a may be a fired electrode including a conductive metal and glass or a resin-based electrode including a conductive metal and a resin.

In addition, the electrode layers 131a and 132a may have a form in which the fired electrode and the resin-based electrode are sequentially formed on the body. Further, the electrode layers 131a and 132a may be formed by transferring a sheet including the conductive metal on the body or on the fired electrode.

The conductive metal including in the electrode layers 131a and 132a may have excellent electrical conductivity, but the present invention is not particularly limited thereto. For example, the conductive metal may be at least one of nickel (Ni), copper (Cu), and an alloy thereof.

Specific examples of the plating layers 131b and 132b may be a Ni plating layer or a Sn plating layer, and herein, the Ni plating layer or the Sn plating layer may be sequentially formed on the electrode layers 131a and 132a, or the Sn plating layer, the Ni plating layer, and the Sn plating layer in order may be formed. In addition, the plating layers 131b and 132b may include a plurality of Ni plating layers and/or a plurality of Sn plating layers.

As one example of multi-layered electronic components, a multi-layer ceramic capacitor is illustrated, but the present invention may also be applied to various electronic products including the aforementioned dielectric ceramic, for example, an inductor, a piezoelectric element, a varistor, a thermistor, or the like.

Hereinafter, specific embodiments of the invention are presented. However, the embodiments described below are only for specifically illustrating or explaining the invention and the scope of the invention is not limited thereto.

### Preparation Example: Preparation of Polycrystalline Dielectric Having Dopant Grain Boundary Segregation Structure

In order for a dopant element to have a grain boundary-based segregation structure after sintering, an excess of dopant precursor powder was first mixed with crystallized barium titanate powder, preparing a mixture.

The crystallized barium titanate and the dopant precursor powder were weighed according to each appropriate ratio. Herein, in order to maintain insulation properties under a reduction sintering condition, a dopant acting as an acceptor for the barium titanate was used, and MnO, Fe₂O₃, NiO, CoO, Al₂O₃, and Ga₂O₃ were respectively used.

In addition, the acceptor dopant was used along with a donor dopant such as Nb₂O₅ and Ta₂O₅, and during the subsequent sintering process, silicon dioxide (SiO₂) was added in a predetermined amount according to the weight ratio of the barium titanate to secure easy densification.

After the weighing, the mixture was wet-milled for 24 hours with a high purity ethanol solvent as a medium with zirconia balls for dispersion and pulverization.

The milled raw powder mixed solution was dried to a slurry state on a hot plate, and then completely dried in an 80° C. or higher oven to remove the remaining solvent.

The dried powder was sufficiently pulverized by using an agate mortar and then sieved with a 75 μm sieve.

Subsequently, the obtained mixed powder was press-molded into a disk shaped pellet of a sample by using a metal mold having a diameter of 8 mm. Then, the pelletized sample was treated through a cold isostatic pressing method under a pressure of 200 MPa for 10 minutes, through which density of a polycrystalline dielectric was more effectively increased during the sintering.

The disk-shaped sample pellet was sintered at 1200° C. for 1 hour by using a vertical heating furnace. In order to perform the sintering under the atmosphere and various reduction atmospheres, four atmospheres such as the air, N₂, 0.5% H₂/N₂, and 1% H₂/N₂ were used, and the sample sintered under the 0.5% H₂/N₂ atmosphere was representatively analyzed.

### Experimental Example 1: Direct Confirmation and Analysis of Dopant Grain Boundary Segregation Structure

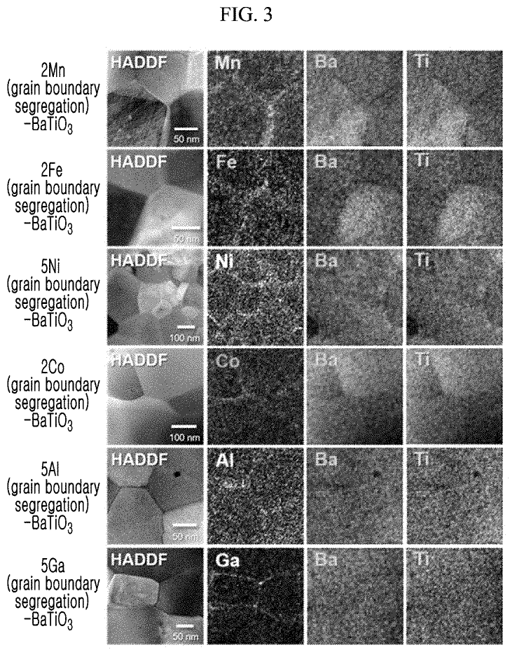

Energy dispersive spectroscopy using a transmission electron microscope was used to directly confirm whether or not a dielectric of the preparation example having a low dielectric loss within a wide range had a grain boundary segregation structure of a dopant, and the results are shown in FIG. 3.

FIG. 3 is an image obtained by measuring the distribution positions of the dielectric elements according to various dopants in the dopant grain boundary segregated dielectric by the energy dispersive spectroscopy. The case where all the different types of dielectrics according to the dopant were fired under the 0.5% H₂/N₂ reduction atmosphere is shown as a representative example. As a result of the energy dispersive spectroscopy, for all types of dielectrics, the element commonly used as a dopant was strongly identified in the grain boundary region of the polycrystalline dielectric regardless of the dopant type. Through this, the dopant grain boundary segregation structure was formed in which the dopant was intensively distributed in the region at the grain boundaries in accordance with the target structure in the embodiment. In addition, it can be inferred that the dopant distribution width is about 5 nm based on the grain boundary center.

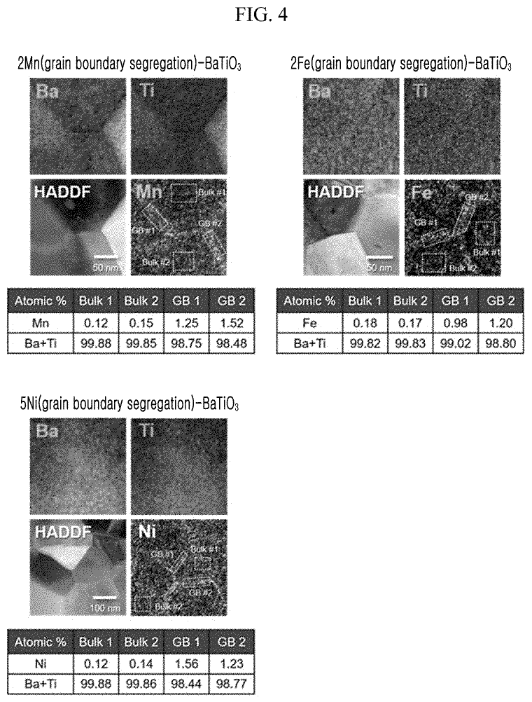

In order to analyze the dopant grain boundary segregation in more detail, a relative quantification analysis was performed with respect to the dopants in crystal grains and at grain boundaries. The results of the dielectrics in which each dopant of manganese (Mn), iron (Fe), and nickel (Ni) was segregated at the grain boundaries are shown in FIG. 4.

FIG. 4 is an image obtained by quantitatively measuring whether the dopant is located at the center of the grain boundary in the dopant grain boundary segregated dielectric by energy dispersive spectroscopy. The case where all the different types of dielectrics according to the dopant are fired in a 0.5% H₂/N₂ reduction atmosphere is shown as a representative example. As a result of the quantitative concentration analysis of the dopants, the dopants had at least 5 times to at most 13 times relatively higher concentration at the grain boundaries than in the crystal grains, through which most of dopant elements were segregated around the grain boundary region.

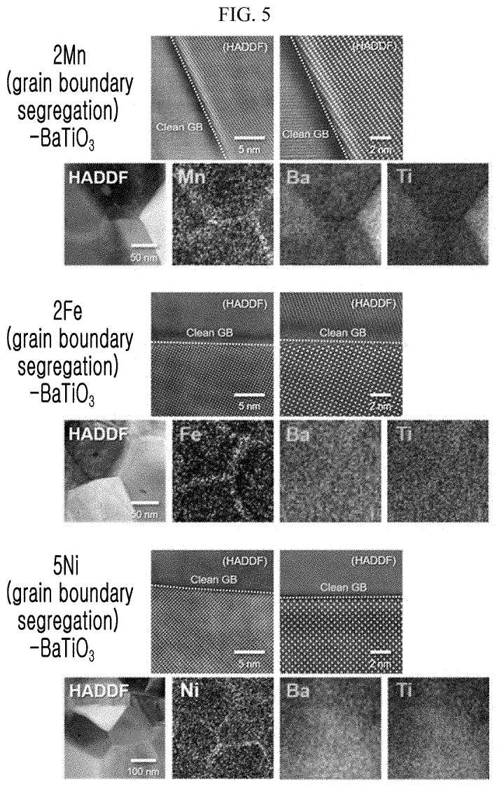

Previously, it was confirmed that the dopants were segregated and distributed at the grain boundaries of the polycrystalline dielectric through the energy dispersive spectroscopy. In order to perform a microscopic analysis of a form in which the dopant was segregated at the boundaries, a scanning transmission electron microscope was used to representatively analyze dielectrics in which manganese (Mn), iron (Fe), and nickel (Ni) were respectively segregated at the grain boundaries, and the results are shown in FIG. 5.

FIG. 5 is a high-angle annular dark field image using an atomic-level scanning transmission electron microscope to confirm the presence of a dopant in the grain boundary region of a dopant grain boundary segregated dielectric. The case where all the different types of dielectrics according to the dopant were fired in a 0.5% H₂/N₂ reduction atmosphere is shown as a representative example. In the atomic-level high-angle annular dark field image, secondary phases were not present in the grain boundaries, and accordingly, a grain boundary structure among crystal grains was perfectly present. Accordingly, the dopants at a high concentration in the grain boundary region, which was confirmed through the energy dispersive spectroscopy, were not present in a secondary phase form but were doped and segregated in the barium titanate-based crystals.

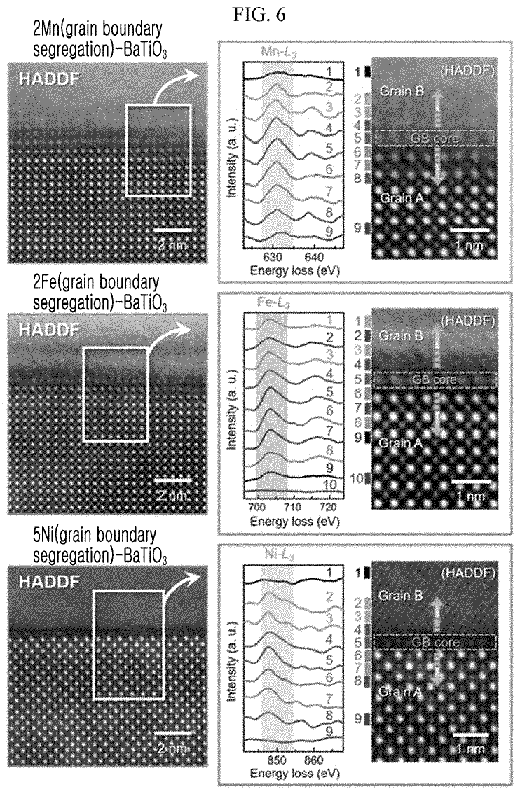

As examined through the energy dispersive spectroscopy and high-angle annular dark field image, the dopants were positioned and segregated in the grain boundary crystals of the polycrystalline dielectric without the secondary phases, and in addition, through the energy dispersive spectroscopy, the segregation was appropriately formed with a width of 5 nm with respect to the center of the grain boundary. In this regard, in order to perform a more microscopic dopant grain boundary segregation structure analysis, the dielectrics in which manganese (Mn), iron (Fe), and nickel (Ni) were respectively segregated in the grain boundaries were analyzed through atomic-level electron energy loss spectroscopy, and the results are shown in FIG. 6.

FIG. 6 shows a result of measuring the distribution structure and grain boundary segregation width of the dopant by using atomic-level electron energy loss spectroscopy in the grain boundary region of the dopant grain boundary segregated dielectric. The case where all the different types of dielectrics according to the dopant were fired in a 0.5% H₂/N₂ reduction atmosphere is shown as a representative example. A concentration of the dopants was consistently the highest in the center of the grain boundary regardless of a type but gradually decreased toward both bulk directions of the crystal grain. Accordingly, the dopant exhibited a distribution region having a range of 2 to 4 unit grid widths based on the grain boundary center and forming a segregation layer of about 2 nm or less, but in the crystal grain bulk region, no distribution of the dopant was found. In conclusion, in an embodiment, a polycrystalline dielectric having a dopant grain boundary segregation structure in which the dopant was segregated within a width of about 2 nm with respect to the grain boundary center was made.

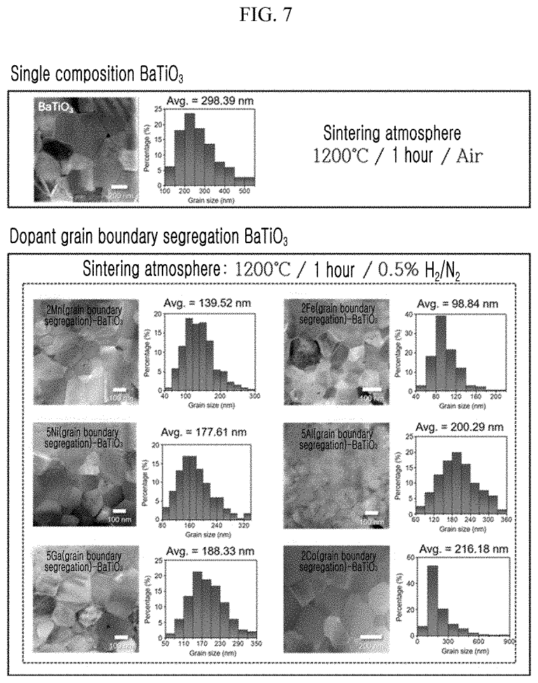

In the dielectric ceramic according to an embodiment, attempts to further reduce a size of crystal grains were made so that the polycrystalline dielectric had a low dielectric loss in a high frequency region of 100 MHz or higher. For this purpose, nano-sized barium titanate powder of about 50 nm was used, and crystal grain growth was more effectively suppressed through the dopant grain boundary segregation structure of an excess dopant. The dopant grain boundary segregated dielectric was examined with respect to a microstructure through a scanning transmission electron microscope, each dielectric depending on a dopant type was measured with respect to a crystal grain size, and the results are shown in FIG. 7.

FIG. 7 shows microstructure analysis and crystal grain size results of a dielectric using nano-sized powder and having a low dielectric loss through a dopant grain boundary segregation structure, which were obtained by using a scanning transmission electron microscope. The case where all the different types of dielectrics according to the dopant were fired in a 0.5% H₂/N₂ reduction atmosphere is shown as a representative example. As a result of measuring crystal grain sizes, although small nano-sized barium titanate powder of 50 nm was used, a dielectric in which an excess of the dopant was segregated at the grain boundaries exhibited more effective suppression of grain growth than barium titanate polycrystals having a single composition which were sintered at the same temperature. In addition, the dielectric exhibited a crystal grain size difference according to the dopant types but still had a much smaller size than the barium titanate having a single composition.

### Experimental Example 2: Analysis of Dielectric Properties According to Frequency

After grinding both sides of the disk-shaped pellet according to the preparation example, a Ag paste was applied thereon through a silk screen technique. Subsequently, a heat treatment at about 650° C. for about 30 minutes was performed.

As described above, the polycrystalline dielectric treated with the Ag electrode was measured with respect to a relative permittivity and a dielectric loss were measured by using an impedance analyzer, while an AC electric field in a frequency range of 100 Hz to 1 GHZ was applied thereto, and the results are shown in FIGS. 6, 7, and 8.

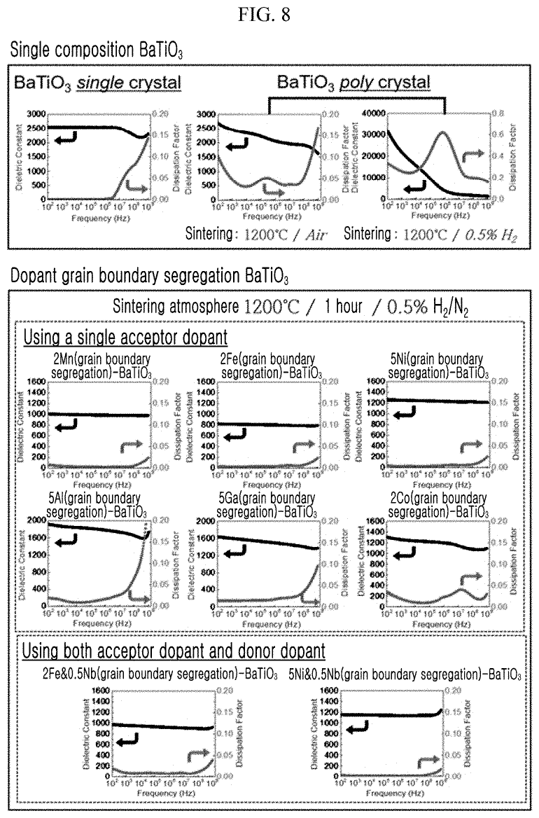

FIG. 6 exhibits dielectric properties depending on a frequency of single-crystalline and polycrystalline barium titanate having a single composition and dopant grain boundary segregated barium titanate sintered under a 0.5% H₂/N₂ atmosphere. Referring to FIG. 8, the single-crystalline barium titanate exhibited extremely low dielectric properties in a low frequency region of less than or equal to 10 MHz but a very high dielectric loss, compared with the polycrystalline barium titanate, and this large dielectric loss difference may be judged as presence or absence of a grain boundary structure.

In addition, the polycrystalline titanate dielectric forming the dopant grain boundary segregation structure in the frequency region of 10 MHz or less exhibited a consistent dielectric loss-reducing effect, compared with the polycrystalline barium titanate having a single composition, which is caused by lowering electrical instability of the grain boundary structure due to the grain boundary segregation of the dopant. Even in a frequency region of 100 MHz or higher, the dielectric loss was effectively reduced due to the excessive dopant segregation effect in the grain boundary region and the suppression of crystal grain growth by using the nanopowder.

In addition, the case of forming the dopant grain boundary segregation structure regardless of types of the dopant commonly exhibited the dielectric loss reduction, but dopant types such as manganese (Mn), iron (Fe), and nickel (Ni) exhibited the most outstanding dielectric loss reduction effect, and accordingly, the samples using the dopant types of manganese (Mn), iron (Fe), and nickel (Ni) and sintered under 0.5% H₂/N₂ were representatively analyzed. Regardless of using a single acceptor dopant and both acceptor dopant and donor dopant, the same dielectric loss reduction effect was obtained, and even when the donor dopant was additionally used, the relative permittivity did not drop. When the acceptor and donor dopants were used together, the acceptor dopant should be used at a higher concentration than the donor dopant in order to maintain insulation properties during the sintering process under reduction conditions.

The types of dopant used in an embodiment acted as an acceptor for barium titanate and exhibited non-reducing properties capable of maintaining high insulation resistance even in the sintering heat treatment under a reduction atmosphere due to distribution of the excess acceptor at the grain boundaries.

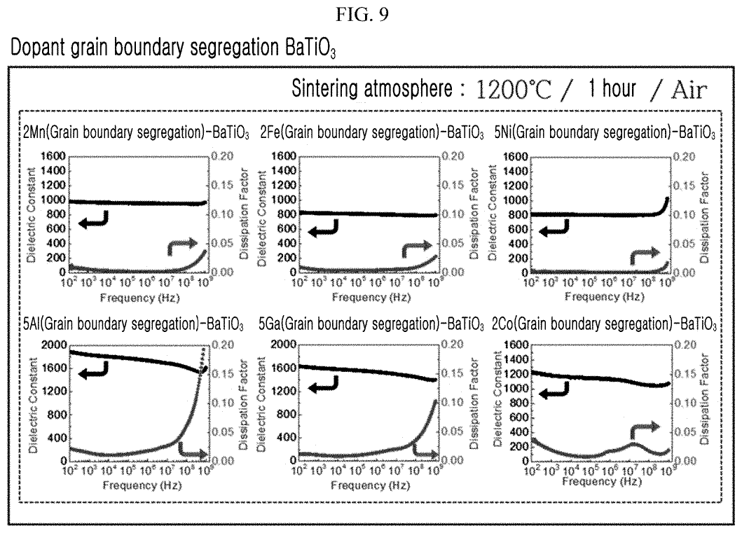

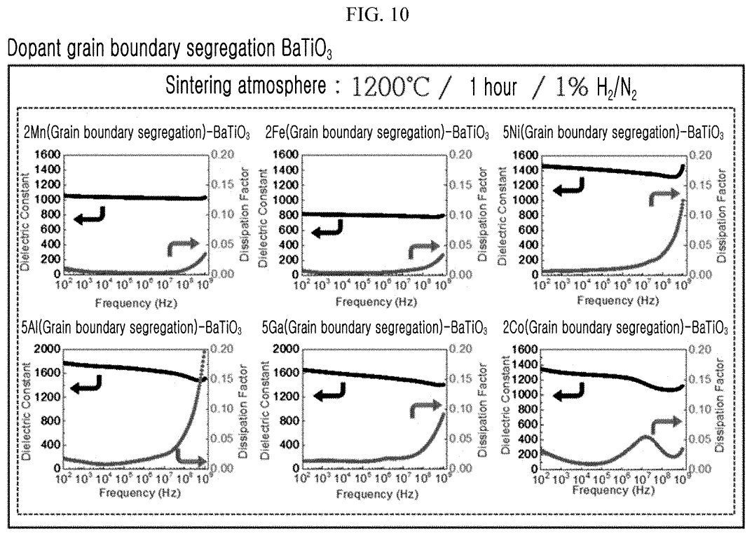

FIGS. 9 and 10 show dielectric properties depending on a frequency of dopant grain boundary segregated barium titanate sintered respectively under the atmosphere and 1% H₂/N₂ in an embodiment. In an embodiment, extrinsic oxygen vacancy defects were suppressed by selectively doping an excess of the acceptor dopant and the acceptor-donor codopant in the grain boundary region and secured the non-reducing properties despite a heat treatment under a reduction atmosphere. Accordingly, FIGS. 9 and 10, including the results of FIG. 8, show consistent non-reducing results even under an atmosphere having an oxygen partial pressure difference of oxidation and reduction.

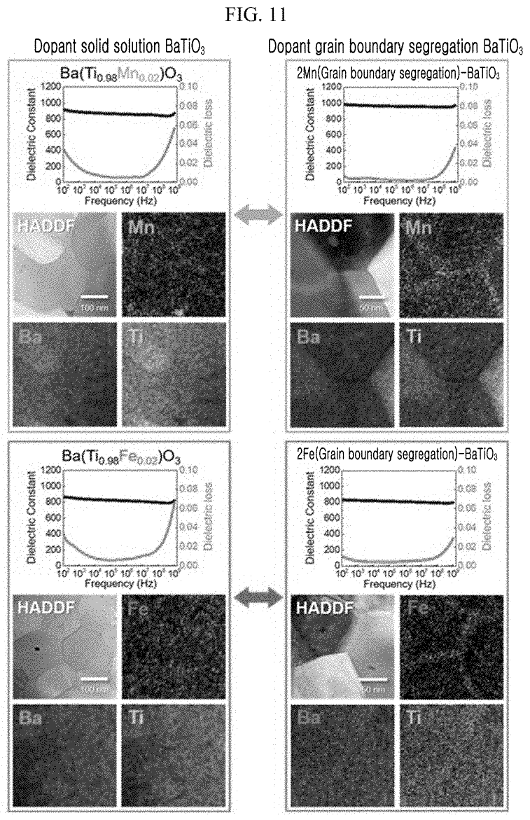

An embodiment provides a dielectric having a dopant grain boundary segregation structure and showing a low dielectric loss, which was directly confirmed to have segregation of the excess dopant in the grain boundary region based on a grain boundary, and it was also confirmed to have a low dielectric loss in the measurement of dielectric properties. A dopant solid solution-type dielectric, in which the dopant was uniformly distributed at the grain boundary and in the bulk, was manufactured for an intuitive comparison with the effective dielectric loss reduction due to the dopant grain boundary segregation structure, and FIG. 11 shows dopant distribution forms and a dielectric property difference between the dopant solid solution-type dielectric and the dielectric having the dopant grain boundary segregation structure.

FIG. 11 shows dopant distribution forms and dielectric properties of barium titanate having the dopant grain boundary segregation structure according to an embodiment and barium titanate having the dopant solid solution type prepared for the comparison experiment. Each dielectric respectively using a manganese (Mn) dopant and an iron (Fe) dopant are representatively shown, which were both heat-treated under a 0.5% H₂/N₂ sintering atmosphere. When the dopant distributions thereof were analyzed through energy dispersive spectroscopy, as shown in the images, the dopants, regardless of types of the dopants, exhibited no segregation tendency at the grain boundaries in the dopant solid solution but were uniformly measured in all regions. Compared with the barium titanate having the dopant grain boundary segregation structure, the dopant solid solution-type barium titanate having a dopant bulk exhibited no effective dielectric loss reduction effect at a low frequency of 10 MHz or less. In addition, the dielectric loss at a high frequency of 100 MHz or higher due to the grain boundary segregate of the excess dopant and the suppression of crystal grain growth by using the nanopowder was also inefficient in the dopant solid solution-type barium titanate.

### Experimental Example 3: Measurement of Polarization and Room Temperature Resistivity According to Direct Current

An Ag paste was coated on both sides of the disk-shaped pellet according to the preparation example. Subsequently, the coated pellet was heat-treated at about a 650° C. temperature for about 30 minutes.

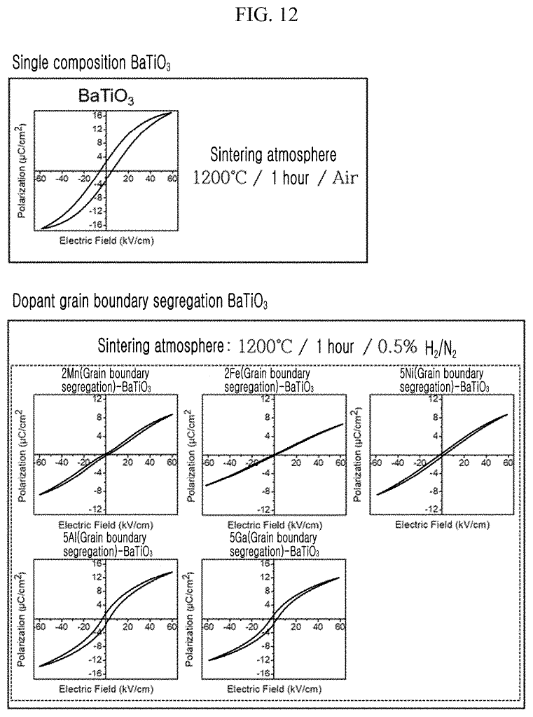

As described above, the dielectric treated with the Ag electrode was applied with a DC voltage of 4000 V to measure a polarization or polarization hysteresis curve according to an electric field by using a ferroelectric characteristic analyzer, and the results are shown in FIG. 12.

FIG. 12 is a view showing a measurement result of a polarization hysteresis curve according to an electric field for polycrystalline barium titanate having a single composition and dopant grain boundary segregated barium titanate. In the case of the dopant grain boundary segregated barium titanate, dopants using nickel (Ni), aluminum (Al), and gallium (Ga) dopant types are shown as representative examples.

The dielectric having the dopant grain boundary segregation structure exhibited a decrease in saturation polarization and anti-electric field, compared with barium titanate with a single composition. This decrease in the polarization hysteresis curve resulted from lowered ferroelectricity according to a small grain size of the dopant grain boundary segregated dielectric and segregation of excess dopant. In addition, the dopant grain boundary segregated dielectric still exhibited the polarization hysteresis curve, which shows that the dopant was segregated with a constant width in the grain boundary region but not diffused into the crystal grain bulk, which is also consistent with the results obtained by energy dispersive spectroscopy and electron energy loss spectroscopy.

The barium titanate having a single composition and the dopant grain boundary segregated dielectric were sintered under each oxidation and reduction atmosphere and treated with a Ag electrode and then measured with respect to insulation resistance under a 250 V DC electric field by using a high resistance-measuring device, and the results are shown in Table 1.

TABLE 1

| | Sintering atmosphere | | | |
|---|---|---|---|---|
| | (1200° C., 1 hour sintering), unit: Ω (cm) | | | |
| | Air | N₂ | 0.5% H₂/N₂ | 1% H₂/N₂ |
| BaTiO₃ | 2.683 × 10¹¹ | less than 10⁷ | less than 10⁷ | less than 10⁷ |
| 2 Mn(grain | 1.227 × 10¹² | 8.254 × 10¹¹ | 7.562 × 10¹¹ | 5.451 × 10¹¹ |
| boundary | | | | |
| segregation)- | | | | |
| BaTiO₃ | | | | |
| 2 Fe(grain | 9.060 × 10¹² | 4.881 × 10¹² | 2.247 × 10¹² | 1.039 × 10¹² |
| boundary | | | | |
| segregation)- | | | | |
| BaTiO₃ | | | | |
| 5 Ni(grain | 4.911 × 10¹¹ | 3.749 × 10¹¹ | 3.310 × 10¹¹ | 1.796 × 10¹¹ |
| boundary | | | | |
| segregation)- | | | | |
| BaTiO₃ | | | | |
| 2 Co(grain | 1.120 × 10¹¹ | 9.623 × 10¹⁰ | 9.524 × 10¹⁰ | 6.899 × 10¹⁰ |
| boundary | | | | |
| segregation) | | | | |
| -BaTiO₃ | | | | |
| 5 Al(grain | 2.262 × 10¹¹ | 1.958 × 10¹² | 1.744 × 10¹² | 1.613 × 10¹² |
| boundary | | | | |
| segregation)- | | | | |
| BaTiO₃ | | | | |
| 5 Ga(grain | 6.514 × 10¹¹ | 3.595 × 10¹² | 3.340 × 10¹² | 3.203 × 10¹² |
| boundary | | | | |
| segregation)- | | | | |
| BaTiO₃ | | | | |
| 2 Fe & 0.5 | | | 2.756 × 10¹¹ | |
| Nb(grain | | | | |
| boundary | | | | |
| segregation)- | | | | |
| BaTiO₃ | | | | |
| 5 Ni & 0.5 | | | 7.541 × 10¹¹ | |
| Nb(grain | | | | |
| boundary | | | | |
| segregation)- | | | | |
| BaTiO₃ | | | | |

When the barium titanate having a single composition was heat-treated through sintering in an oxidizing atmosphere under atmospheric conditions, high insulation properties of 10¹⁰ ohm-cm or higher were maintained. However, when sintered in a reduction atmosphere under a low oxygen partial pressure such as 0.5% H₂/N₂, the insulation properties were lost, but conductivity was increased, which makes it impossible to use it as a dielectric. In order to manufacture a multi-layer ceramic capacitor, a ceramic dielectric is required to have non-reducing properties under a low oxygen partial pressure to prevent oxidation of a metal electrode. The dopant grain boundary segregated dielectric of an embodiment turned out to maintain high insulation properties of 10¹⁰ ohm-cm or higher even in a sintering heat treatment of 1% H₂/N₂ by using and segregating a dopant acting as acceptor. Accordingly, the dopant grain boundary segregation structure dielectric according to the preparation example may maintain high insulation properties in sintering heat treatment under a reduction atmosphere and exhibits practical applicability as a multi-layer ceramic capacitor.

While this invention has been described in connection with what is presently considered to be practical example embodiments, it is to be understood that the invention is not limited to the disclosed embodiments. On the contrary, it is intended to cover various modifications and equivalent arrangements included within the spirit and scope of the appended claims.

### DESCRIPTION OF SYMBOLS

100: multi-layered electronic component
110: body
121, 122: internal electrode
111: dielectric layer
112, 113: cover portion
131, 132: external electrode

What is claimed is:

1. A dielectric ceramic, comprising
a plurality of crystal grain bulks including a ceramic represented by Chemical Formula 1, and
a grain boundary between the plurality of crystal grain bulks,
wherein a dopant is segregated at the grain boundary:
ABO₃ [Chemical Formula 1]
wherein, in Chemical Formula 1,
A necessarily includes Ba and further includes Ca, Sr, or a combination thereof, and
B necessarily includes Ti and further includes Zr, Hf, Sn, or a combination thereof.

2. The dielectric ceramic of claim 1, wherein the dopant comprises Mn, Fe, Ni, Co, Al, Ga, or a combination thereof.

3. The dielectric ceramic of claim 1, wherein the dopant comprises Nb, Ta, La, Sm, Dy, or a combination thereof.

4. The dielectric ceramic of claim 1, wherein the dopant is present in an amount of greater than or equal to about 90 mol % based on the total moles of the dopant within about 5 nm from the center of the grain boundary.

5. The dielectric ceramic of claim 1, wherein the dopant is present in an amount of about 85 mol % to about 95 mol % based on the total moles of the dopant within 2 nm from the center of the grain boundary.

6. The dielectric ceramic of claim 1, wherein the crystal grain bulk has an average grain diameter of less than or equal to about 150 nm.

7. The dielectric ceramic of claim 1, wherein the dopant is included in an amount of about 0.01 parts by mole to about 0.20 parts by mole based on 1 part by mole of the ceramic.

8. The dielectric ceramic of claim 1, wherein a tetragonality of the plurality of crystal grain bulks ranges about 1 to about 1.005.

9. The dielectric ceramic of claim 1, wherein the dielectric ceramic has a dielectric loss of less than or equal to about 1% in a frequency region of less than or equal to about 100 MHz.

10. A method of preparing a dielectric ceramic, comprising:
preparing a crystallized ceramic powder;
mixing a dopant precursor with the crystallized ceramic powder to prepare a mixture; and
sintering the mixture at a temperature of less than or equal to about 1300° C.

11. The method of claim 10, wherein the crystallized ceramic powder has an average particle diameter of less than or equal to about 50 nm.

12. The method of claim 10, wherein the dopant precursor comprises MnO, Fe₂O₃, NiO, CoO, Al₂O₃, Ga₂O₃, or a combination thereof.

13. The method of claim 10, wherein the dopant precursor comprises Nb₂O₅, Ta₂O₅, La₂O₃, Sm₂O₃, Dy₂O₃, or a combination thereof.

14. The method of claim 10, wherein the dopant precursor is included in an amount of about 0.01 parts by mole to about 0.20 parts by mole based on 1 part by mole of the ceramic powder.

15. The method of claim 10, wherein the dopant precursor has an average particle diameter of less than or equal to about 200 nm.

16. The method of claim 10, wherein the mixture comprises SiO₂ in an amount of about 0.1 parts by mole to about 10 parts by mole based on 100 parts by mole of the ceramic powder.

17. The method of claim 10, wherein the sintering of the mixture is performed at a temperature of about 1000° C. to about 1300° C. for a time of less than or equal to about 5 hours.

18. A multi-layered electronic component, comprising:
a body including a dielectric layer and an internal electrode; and
an external electrode disposed on the body and connected to the internal electrode,
wherein the dielectric layer comprises the dielectric ceramic of claim 1.
